(19) United States
(12) Patent Application Publication
(10) Pub. No.: US 2024/0049615 A1
(43) Pub. Date: Feb. 15, 2024

(54) SYSTEM AND APPARATUS FOR FACILITATING VEGETATION CONTROL

(71) Applicant: STEAMWAND TECHNOLOGY PTY LTD, Chatswood, New South Wales (AU)

(72) Inventor: Jeremy WINER, Chatswood, New South Wales (AU)

(21) Appl. No.: 18/263,501

(22) PCT Filed: Jan. 31, 2022
(86) PCT No.: PCT/AU2022/050049

§ 371 Date: Jul. 28, 2023

Related U.S. Application Data
(60) Provisional application No. 63/143,902, filed on Jan. 31, 2021.
(60) Provisional application No. 63/143,904, filed on Jan. 31, 2021.

(51) Int. Cl. A01B 63/28; A01M 21/04; A01M 7/00

(52) U.S. Cl. CPC A01B 63/28; A01M 21/043; A01M 7/0071

(57) ABSTRACT

The present invention is directed to apparatuses, methods, and systems that provide a tracking assembly adapted to be used with a vegetation control system, the assembly comprising: an articulating frame; a pivoting frame coupled to the articulating frame along a pivot axis; a vegetation control application system coupled to the pivoting frame; a first ground tracking device coupled to the articulating frame configured to contact a surface underneath the articulating frame and position the articulating frame relative to the surface underneath the articulating frame; and a second ground tracking device coupled to the pivoting frame configured to contact a surface underneath the pivoting frame and position the pivoting frame and vegetation control application system relative to the surface underneath the pivoting frame, wherein the second ground tracking device pivots the pivoting frame about the pivot axis when an elevation of the surface underneath the second tracking device is different to an elevation of the surface underneath the first tracking device.

### FIELD OF THE INVENTION

The present invention relates to systems and apparatus for facilitating deployment and use of applicators from vehicles or mobile platforms carrying or using the applicators. More specifically, the present invention relates to systems and apparatus for facilitating deployment and use of vegetation control applicators from vehicles or mobile platforms carrying or using the vegetation control applicators.

### BACKGROUND

Various methods are known and recognized as being effective for controlling the growth of unwanted vegetation, such as soft wooded annual or perennial weeds. These methods are used in the agricultural and horticultural industry for controlling competing vegetation in vegetable and herb fields, pastures, fence lines, drainage channels, swales, orchard rows, vineyards, and storage, production, parking, access areas, and so on. Around the world, municipal and government bodies are required to manage and control vegetation in public areas, such as paths, curbs, gutters, garden beds, tree pits, malls, alleys, recreational reserves and environmental preservation reserves.

The methods and products available for agricultural, horticultural and landscape maintenance machines and processes that minimize impact on our environment has grown over the last two decades. In particular, there is increased adoption of methods that destroy, fertilise, or otherwise control unwanted vegetation, such as, for example, invasive species, asset destroying species, and plants competing with crops for nutrients, moisture and light. Hereinafter, the term “control” when used in relation to vegetation is intended to mean destruction, fertilise, pesticisize, herbicize, or otherwise control. Chemicals, fertilisers, pesticides and/or herbicides continue to be used to control vegetation and there is also demand for systems which do not use chemicals, fertilisers, pesticides, fungicides, and/or herbicides.

### Chemicals, Herbicides, Fungicides, and Pesticides

Typically, vegetation control has been implemented through the use of chemicals and/or herbicides. Chemicals also have been used to inhibit undesired diseases and maladies in plants, such as fungicides, and pesticides have been applied to reduce, control, or eliminate insects or other organisms harmful to cultivated plants. Hereinafter, the term “chemicals” will be used to refer chemicals, herbicides and/or pesticides

However, concerns with the environmental impact of these chemicals have increased with the amount of application and understanding of their effects on the overall ecosystem. Indeed, one of the problems associated with chemical treatment is undesired spread or drift of chemicals during their application. For example, chemicals are typical applied by spraying an aqueous solution on vegetation and/or on ground surrounding vegetation. Because the solution is sprayed, a certain amount of the chemicals become aerosols that may easily spread via air currents. This can result in dilution of the chemicals, requiring an application of higher concentration of chemicals to be effective. This in turns leads to over saturation of chemicals in the environment. In addition, other crops, water supplies, and livestock may be harmed via unintended application. As a result, chemical application may be restricted by current atmospheric conditions and weather.

Furthermore, the application of chemicals for vegetation control can have undesirable secondary effects, including from overuse. For example, overuse or spread can harm ecological processes and non-target species, and health-related harm to workers applying the chemicals has been proven.

There is, therefore, ongoing demand for new or improved methods and/or apparatus which minimize the amount of chemicals necessary to achieve vegetation control. One such method involves the use of specially designed applicators, such as sprayers, to provide a certain droplet size that is optimized to spread chemical over only a short distance due to gravity's effect on the individual droplets. Another method is to use some kind or shield or shroud to focus application to a specific area or plant and thereby minimize undesired spread of the chemical. However, both of these methods have flaws.

Existing designs are susceptible to environmental conditionals, especially wind, which can result in limiting times when the sprayer/application can be used and/or resulting in unwanted drift of chemicals in the environment. Similarly, the existing shrouds can be imperfect as well. Existing shrouds increase the difficulty of chemical application in terrains with different types of elevations, obstacles, and plants. For example, existing shrouds that do not match the terrain lead to gaps which allow unwanted vegetation spread. In order to reduce spread, the positioning of the shroud is manually adjusted by an operator; however, this can be time consuming resulting in only minor and/or occasional adjustments thereby reducing effectiveness of existing shrouds.

Moreover, the recognition that accounting for the subsequent health and safety costs, potential for contamination of water supplies, soils and off target damage, as well as the growing demand for pesticide free food and public spaces has resulted in increased demand for alternatives to chemical vegetation control.

Use of Heat (Typically with Water), in Lieu of Chemicals

An area of product development that has seen new machine products come to market in the past 15 years, or so, which adopt thermal vegetation control and, in particular, hydrothermal vegetation control. Hydrothermal systems generate heated water, steam, saturated steam and boiling water, which can be applied directly to vegetation to destroy cell structure of the vegetation promoting plant destruction and death.

However, many problems exist with such technology. For example, although partially effective, most processes and machines result in only superficial destruction of the above ground portion of the target vegetation. As a result, there is a rapid regrowth of vegetation in response to the treatment. This leads to a high frequency of application of the hydrothermal weed control, which can become cost prohibitive due to the frequency of application.

Furthermore, these hydrothermal application products typically do not deliver enough volume of liquid at a high enough temperature to penetrate the crown of the plant where the meristematic cells are located, which sells ought properly to be destroyed in order to retard or stop the regrowth of the treated plant. Therefore, optimal application is important to effectiveness of vegetation and weed control, energy consumption, and the amount of water required.

### Systems Adopting Hydrothermal and Chemical Methodologies

There are systems on the market for controlling vegetation which adopt both hydrothermal and chemical methodologies. Although the combination of hydrothermal and chemical vegetation control can, in some instances, achieve a different level of control to those systems adopting chemical control or hydrothermal control, these combination systems also suffer from several of the problems identified above.

### Terrain Challenges

Environments where vegetation control can be necessary are typically organized into specific planting arrangements. Different planting arrangements may be used, for example, for vegetables, trees, vineyards, among others. Some arrangements may include rows, while others may include mounded forms of various size and slope, depending, for example, on the crop, tree, or plant. In cases of municipal and public areas, including public parks, playgrounds, and so on, the arrangements of different trees, plants, and amenities, may be arbitrary. As a result, varied terrain conditions may exist within the same farm, vineyard, or landscape. Because the environment within horticulture environments can vary tremendously it can be difficult and time consuming to adjust and/or control the positioning of the applicator head or shroud to ensure proper or optimal application.

There is a need for improved systems and apparatus for facilitating vegetation control, which address or ameliorate some or all of the above mentioned problems. Some such improved systems or apparatus may, for example, achieve various efficiencies by increasing effectiveness of vegetation control, reducing the volume of water and/or chemicals necessary to control vegetation, reducing costs of system operation (e.g., cost of water, chemicals, and/or heating, as well as operator time), and/or reducing the need to manually adjust the application system configuration.

Any reference to or discussion of any document, act or item of knowledge in this specification is included solely for the purpose of providing a context for the present invention. It is not suggested or represented that any of these matters or any combination thereof, formed at the priority date, part of the common general knowledge, or was known to be relevant to attempt to solve any problem with which this specification is concerned.

### SUMMARY OF THE INVENTION

In this specification, a discussion of embodiments of the invention describing the device, should be understood to be embodiments applicable to all aspects of the device of the invention, unless specifically indicated. Even then, persons skilled in the art will readily appreciate which embodiments are adoptable for which aspects of the device of the invention. The same approach is applicable to embodiments of the invention describing method aspects, or any other aspects, of the invention.

In one aspect the present invention provides, a tracking assembly adapted to be used with a vegetation control system, the assembly comprising:
an articulating frame;
a pivoting frame coupled to the articulating frame along a pivot axis;
a vegetation control application system coupled to the pivoting frame;
a first ground tracking device coupled to the articulating frame configured to contact a surface underneath the articulating frame and position the articulating frame relative to the surface underneath the articulating frame; and
a second ground tracking device coupled to the pivoting frame configured to contact a surface underneath the pivoting frame and position the pivoting frame and vegetation control application system relative to the surface underneath the pivoting frame,
wherein the second ground tracking device pivots the pivoting frame about the pivot axis when an elevation of the surface underneath the second tracking device is different to an elevation of the surface underneath the first tracking device.

According to some preferred and some alternative, the first ground tracking device includes a first wheel attached to the articulating frame and the second ground tracking device includes a second wheel attached to the pivoting frame, wherein each wheel is configured to roll over the surface underneath the corresponding tracking device. Preferably, the first ground tracking device includes two first wheels.

In some preferred and alternative embodiments, the articulating frame further includes an articulating arm, wherein the arm is adapted for detachably mounting the assembly to a vehicle or a mobile platform transporting the assembly and articulates as an elevation of the surface underneath the first tracking device varies. Preferably, the articulating frame further includes a second articulating arm, the two articulating arms generally forming part of a variable parallelogram.

Some preferred and some alternative embodiments provide that the pivoting frame includes a self-adjusting arm coupled to the vegetation control application system for adjusting a position of the self-adjusting arm when the vegetation control application system contacts obstacles.

Preferably, the vegetation control application system is adapted to deliver hydrothermal treatment solutions, chemical treatment solutions, or a mixture thereof.

In some embodiments wherein the vegetation control application system is adapted to deliver hydrothermal treatment solutions, the vegetation control application system includes a saturated steam application nozzle and a hood configured to concentrate saturated steam and moisture from the application nozzle.

In some embodiments wherein the vegetation control application system is adapted to deliver chemical treatment solutions, the vegetation control application system includes an application nozzle and a hood configured to contain a chemical solution dispersed.

According to another aspect, the present invention provides a vegetation control system comprising:
a tank;
optionally, a heating apparatus;
optionally, control circuitry;
a pump configured to receive a solution from the tank and pressurize solution,
a tracking assembly; and
and a vegetation control application system connected to the tracking system configured to receive and disperse the pressurized solution,
wherein the tracking assembly is adapted to adjust the vegetation control application system relative to a surface having varying elevations.

In particular preferred and alternative embodiments, the tracking assembly comprises:
an articulating frame;
a pivoting frame coupled to the articulating frame along a pivot axis and coupled to the vegetation control application system;
a first ground tracking device coupled to the articulating frame configured to contact a surface underneath the articulating frame and position the articulating frame relative to the surface underneath the articulating frame; and
a second ground tracking device coupled to the pivoting frame configured to contact a surface underneath the pivoting frame and position the pivoting frame and vegetation control application system relative to the surface underneath the pivoting frame,
wherein the second ground tracking device pivots the pivoting frame about the pivot axis when an elevation of the surface underneath the second tracking device is different to an elevation of a surface underneath the first tracking device.

In some preferred and some alternative embodiments, the first ground tracking device includes a first wheel attached to the articulating frame and the second ground tracking device includes a second wheel attached to the pivoting frame, wherein each wheel is configured to roll over the surface underneath the corresponding tracking device. Preferably, the first ground tracking device includes two first wheels.

Preferred and alternative embodiments provide that the articulating frame further includes an articulating arm, wherein the arm is adapted for detachably mounting the tracking assembly to a vehicle or a mobile platform transporting the assembly and articulates as an elevation of the surface underneath the first tracking device varies. Preferably, the articulating frame further includes a second articulating arm, the two articulating arms generally forming part of a variable parallelogram.

In some preferred and some alternative embodiments, the pivoting frame includes a self-adjusting arm coupled to the vegetation control application system for adjusting a position of the self-adjusting arm when the vegetation control application system contacts obstacles.

Preferably, the vegetation control application system is adapted to deliver hydrothermal treatment solutions, chemical treatment solutions, or mixtures thereof.

In embodiments wherein the vegetation control application system is adapted to deliver address thermal treatment solutions, the vegetation control application system includes a saturated steam application nozzle and a hood configured to concentrate saturated steam and moisture from the application nozzle.

In embodiments wherein the vegetation control application system is adapted to deliver chemical treatment solutions, and includes an application nozzle and a hood configured to contain a chemical solution dispersed.

### BRIEF DESCRIPTION OF THE DRAWINGS

The following description illustrates embodiments, or components of embodiments, of the disclosed apparatuses, methods, and systems by way of examples, which are non-limiting and illustrative, with reference to the accompanying drawings, in which:

FIG. 1A shows an example of two tracking systems according to one embodiment of the invention each connected to an opposing side of a portion of a trailer; each connection is, in this embodiment, downstream from the tractor/trailer coupling. Two similar weed control applicators according to one embodiment of the invention are each loaded/engaged to each tracking system. Viewed from the front of the tractor facing the trailer, the tracking system seen on the left is extended in a ground engaging configuration. The tracking system seen on the right is in a retracted configuration.

FIG. 1B provides a schematic diagram of the system according to one embodiment which is adapted to deliver hydrothermal treatment fluid for vegetation control.

FIG. 1C provides a schematic diagram of the system according to one embodiment which is adapted to deliver chemically-based treatment fluid for vegetation control.

FIGS. 2A and 2B shows schematic illustrations of an element of a tracking system according to one embodiment of the invention on surfaces with different contours.

FIG. 2C shows a plan view schematic illustration of an element of a tracking system according to one embodiment of the invention with an application system loaded/engaged.

FIG. 3A is a side elevated perspective view of a tracking system according to one embodiment of the invention without an application system loaded/engaged.

FIG. 3B is a side elevated perspective view of the tracking system according to the embodiment of the invention depicted in FIG. 3A with the applicator engagement/loading arm extended so as to be able to accommodate a larger or different shaped applicator than that accommodated by the configuration of the applicator engagement/loading arm depicted in FIG. 3A.

FIG. 4A is a side elevated perspective view of the tracking system according to the embodiment of the invention depicted in FIG. 3A with a vegetation control applicator according to one embodiment of the invention as loaded/engaged.

FIG. 4B is a side elevated perspective view of the tracking system according to the embodiment of the invention depicted in FIG. 3A with the applicator engagement/loading arm extended and the tracking system is engaging/loading a vegetation control applicator according to an embodiment of the invention which is of larger size than the vegetation control applicator embodiment engaged/loaded in the tracking system depicted in FIG. 4A.

FIG. 5 is an exploded view of components forming part of a tracking system according to the embodiment of the invention depicted in FIG. 4A with a vegetation control applicator according to an embodiment of the invention also depicted in FIG. 4A as loaded/engaged.

FIG. 6A is a side view of the tracking system according to one embodiment of the invention includes a boom extension. The tracking system depicted has loaded/engaged a vegetation control applicator according to the embodiment of the invention depicted in FIG. 4A. The tracking system is shown in a ground engaging configuration with the boom extension in an extended configuration.

FIG. 6B is a side view of the tracking system according to the embodiment of the invention depicted in FIG. 6A with the boom extension in a retracted configuration.

FIG. 6C is a side view of the tracking system according to the embodiment of the invention depicted in FIG. 6A in a retracted configuration, with the boom extension in a retracted configuration.

### DETAILED DESCRIPTION OF SOME PREFERRED AND SOME ALTERNATIVE EMBODIMENTS

In this specification, terms of orientation are used for purposes of explanation and description in several cases having relative regard to other components in the corresponding figure. Persons skilled in the art would appreciate that the terms of orientation used do not necessarily correspond to “real-world” orientations. For example, a component described as vertical for a configuration described in conjunction with a drawing may be horizontal in a “real-world” circumstance due to the various mounting options and/or movement of components in operation.

Preferred and alternative embodiments of the present invention are principally directed to a system and apparatus for facilitating vegetation control, which is adapted to accommodate the application of chemical solutions, hydrothermal solutions, or combinations thereof. In this detailed description, unless context requires otherwise, terms such as “application system”, “applicator”, “sprayer”, and terms having or denoting the same or similar meaning as any of those terms, as well as component parts of them, such as “nozzle” and “shroud”, and terms having or denoting the same or similar meaning as any of those terms, are to be understood to refer to those items adapted for the delivery of chemical solutions, hydrothermal solutions, or combinations thereof. As will be further discussed, and as persons skilled in the art would readily appreciate, whilst this detailed description of some preferred and some alternative embodiments principally focus on the use of applicator is adapted to control vegetation, applicators of other kinds could also be loaded/engaged with the tracking system and used according to their purpose, without falling outside the scope of the invention.

Whilst the description tends to focus on application systems adapted to deliver thermal treatment solutions, chemical treatment solutions, or combinations thereof, to control vegetation, persons skilled in the art will appreciate that the invention could be used for different application systems, such as, for example, undervine mowers, grass/weed clippers, and lawnmowers, to name a few.

Preferred and alternative embodiments disclose a tracking system (10) adapted to accommodate the application of chemical solutions, hydrothermal solutions, or a combination thereof, for vegetation control. Tracking system (10) is adapted to provide or improve efficiencies in the application of vegetation control solutions. The tracking system (10) of preferred and alternative embodiments is adapted to load/engage application system (20) enabling application system (20) to navigate varied terrains. Such varied terrains are commonly found in horticultural environments, such as those in parks, landscapes, farms and vineyards. Because the tracking system of preferred embodiments is self-adjusting, efficiency of vegetation control application is increased while cost and maintenance of controlling vegetation is reduced and/or minimized, relative to some other prior art application systems.

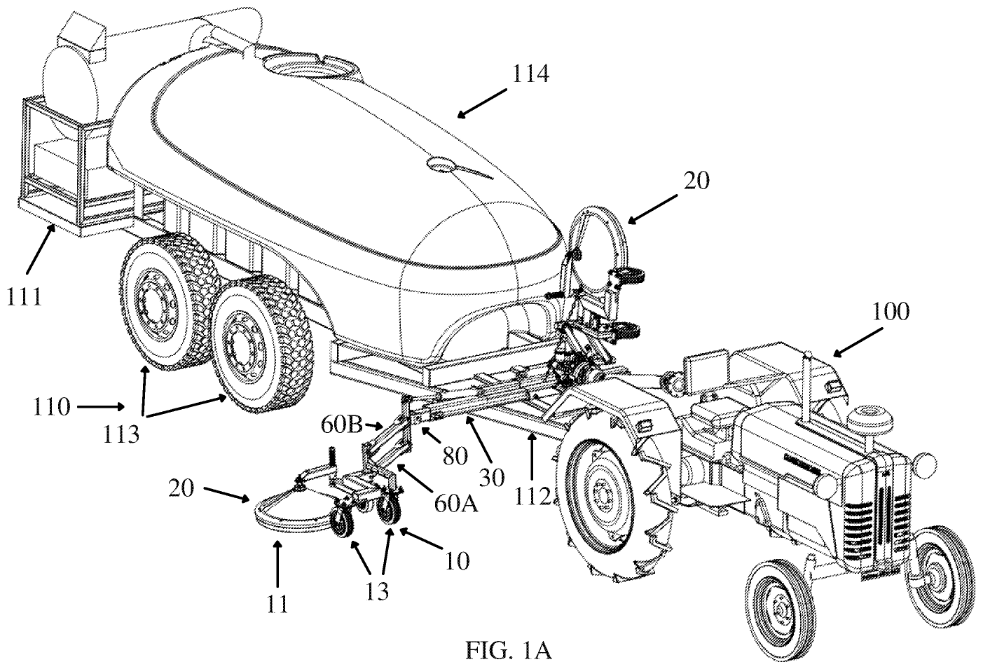

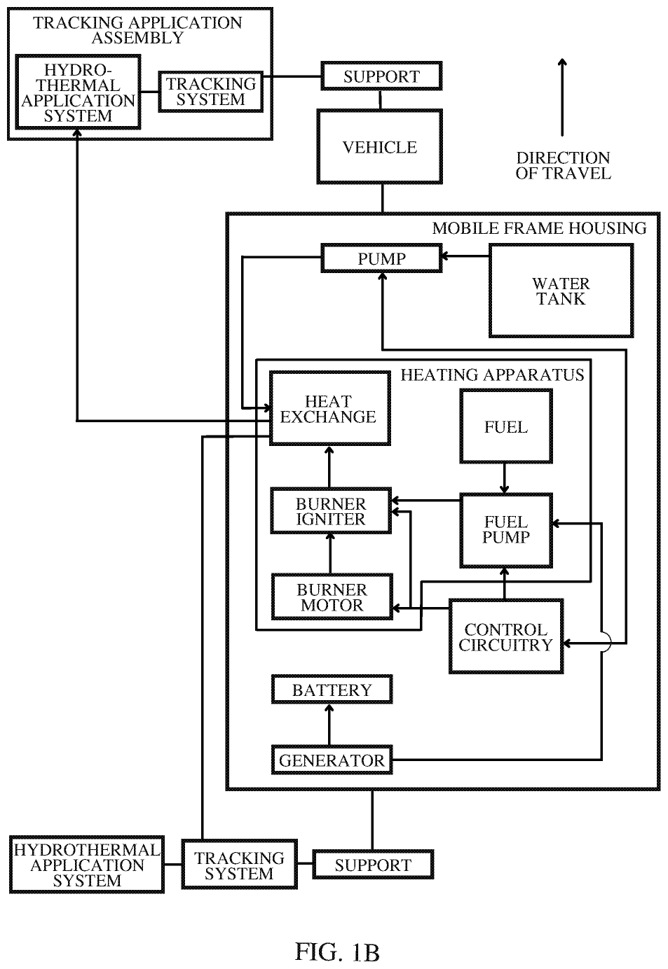

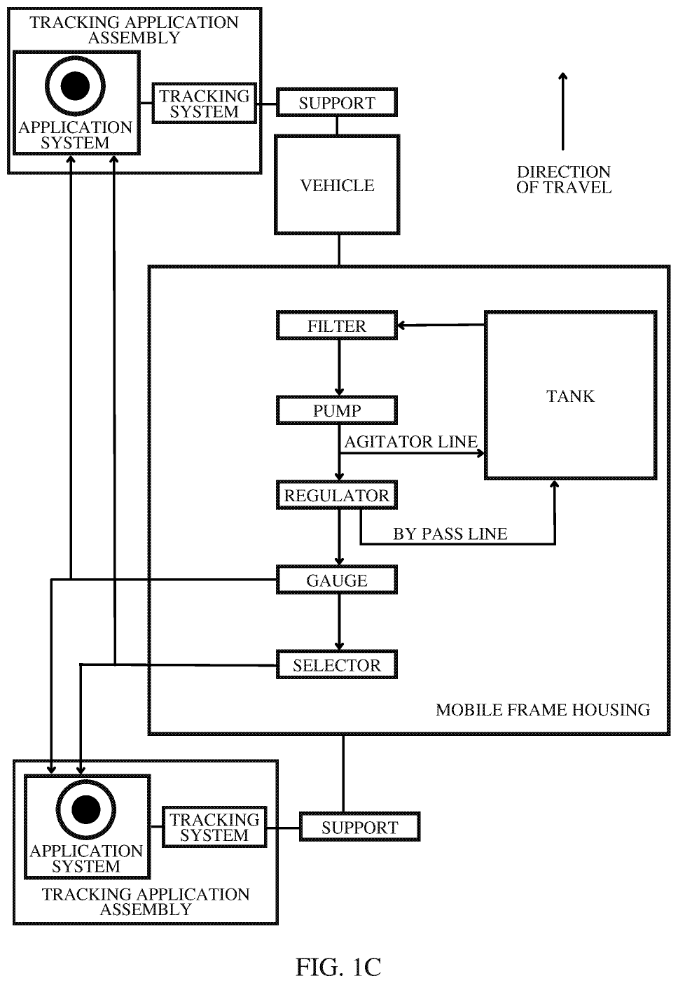

For example, FIG. 1A shows an example of a preferred embodiment of the invention in use with a tractor (100) and trailer (110) coupled arrangement. Two tracking systems (10) are each connected to an opposing portion of a side of a trailer (110), with each tracking system connection (not shown) downstream from the tractor (100) and trailer (110) coupling (not shown). Two similar weed control applicators (20) are each loaded/engaged to each tracking system (10).

The system includes a vehicle (100) and a mobile frame assembly (110). The vehicle (100) may include a mechanical mount or support (30) that attaches to a tracking system (10) loaded/engaged with an application system (20). In some embodiments, the vehicle (100) is a tractor. Multiple tracking systems (10) and application systems or assemblies (20) are mounted to the vehicle (100) and/or the mobile frame assembly or trailer (110). In addition, tracking system or assembly (10) and application system (20) can be mounted at various points of the vehicle (100) or frame assembly (110).

The mobile frame assembly (110) can hold and transport various components of the system. For example, the mobile frame assembly (110) can be made from steel tubular construction forming a mobile frame bed (111) with mobile frame axles (112) and mobile frame wheels (113) for mobility. In one example, two mobile frame axles (112) are used to provide two sets of two mobile frame (113) wheels allowing the mobile frame assembly (110) to travel over various terrain and bear and disperse the weight of the components, for example, water required for the application system (20) to turn into hydrothermal treatment fluid, or chemical liquid(s) for dispersion by the application system (20), or both water and chemicals. The mobile frame (110) also includes a hitch allowing the mobile frame (110) to be attached to and towed by the vehicle (100). An optional braking system also may be provided (not shown). In another example, the frame assembly (110) may be implemented as a skid, for example, a frame without wheels allowing easy transport and/or installation of the system on a means of transportation (e.g., a trailer or vehicle). In another example the mobile frame assembly (110) is directly mounted to the vehicle (e.g., via a hitch, a mount, a bracket, a platform, a coupler, or other means of adaption), which may obviate the need for wheels and towing.).

In the text that follows, there is disclosure of the elements of the system which, in some preferred and alternative embodiments, which are generally enclosed within mobile frame housing (114) on the mobile frame (110).

### Hydrothermal Treatment Fluid Application

FIG. 1B provides a schematic diagram of the system according to one embodiment which is adapted to deliver hydrothermal treatment fluid for vegetation control.

Positioned on the mobile frame (110) in embodiments wherein the application system (20) is adapted to provide hydrothermal treatment fluid are, for example, a water tank, a water pump, a heating apparatus, and control circuitry. The mobile frame assembly (110) of some such embodiments also includes a power source, such as a generator and/or a battery to power various components, the control circuitry and pumps.

In one example of embodiments adapted to deliver hydrothermal treatment fluid, the heating apparatus is a heat exchanger, a burner with an ignitor and a fan motor, a fuel source and a fuel pump. However, other arrangements can be used to heat the water used in the system. For example, water heaters, boilers, induction heaters among other heating systems may be used.

In some such embodiments the water pump is connected to the water tank and the heat exchanger. Water from the tank is pumped by the water pump to the heat exchanger where it is heated by the burner. In some implementations, the pump may be driven by a power takeoff from the tractor. In other examples, the pump may be an electric pump driven by a power source from the vehicle (100) or frame assembly (110), such as the generator or a battery.

The generator can also supply power to the control circuitry, and then subsequently to the fuel pump, the ignitor and the fan motor of the burner. For example, fuel is pumped to the burner by an electric fuel pump. The fuel is ignited by an electric ignitor in the burner. The burner burns the fuel to heat the water in the heat exchanger to a desired temperature at a desired pressure, as described in further detail below. The control circuitry is connected to the fuel pump, the ignitor, and the fan of the burner to control the application, ignition, and burning of the fuel to heat the water in the heat exchanger according to operating parameters.

The water in the heat exchanger is superheated and supplied under pressure to one or more application systems (20) through one or more of various tubes, pipes, and fittings (not shown). One or more selectors also may be included to determine which nozzles and/or application systems (20) are positioned by a tracking system (10) attached, otherwise connected, or mounted to the vehicle (100) or mobile frame assembly (110) to position the application systems (20) in close proximity to the ground, when in use on ground vegetation.

Each application system (20) includes at least one applicator head and a hood assembly. The pressurized, heated water is pumped to the applicator head (21) where it passes through an applicator nozzle (22) to an expansion chamber to create saturated steam and boiling water, which then exits the chamber through a plurality of orifices (not shown) and is applied to the vegetation under the applicator hood (23). The applicator hood assembly (23) insulates and contains the saturated steam and boiling water. By maintaining the temperature in close proximity to the plants for a particular period of time, the saturated steam and boiling water destroys the above ground leaves, shoots, and stems of the plants. The saturated steam and boiling water may also penetrate the ground and potentially kill the plants' root system. Although, this example applies saturated steam and boiling water, other combinations of hot water, boiling water, and steam may be used, with varying degrees of efficacy.

The heat exchanger and pump are used to generate pressurized water at a temperature of preferably between 100° C. to 125° C. and at a pressure of 5 to 100 bar. At atmospheric pressure, water of that temperature turns to steam; however, because the water is under pressure the water's boiling point is raised and the water remains a liquid and, in some embodiments, is referred to as superheated. The pressurized, superheated water passes down an input feed hose/tube until it reaches the applicator nozzle (22) of the applicator head assembly (not shown). The water passes through the applicator nozzle (22) and then enters a depressurizing chamber where the pressure is approximately or slightly higher than ambient atmospheric pressure (e.g., approximately 2 bar). The applicator nozzle (22) maintains the pressure of the water in the input feed tube/hose running from the heat exchanger at 5 to 100 bar. However, once the water passes through the applicator nozzle (22), the water enters the depressurizing chamber where the pressure of the water is reduced to approximately ambient atmospheric pressure or slightly higher pressure (e.g., approximately 2 bar). The reduction of the pressure on the released water lowers the boiling point of the water back to approximately 100° C. Preferably, the water expands and is transformed into a combination of water vapor and water droplets (e.g., saturated steam) and coalesces in the small chamber into boiling water. The mixture of saturated steam and boiling water then exits the chamber through a plurality of orifices (not shown) and is applied to vegetation beneath the applicator hood assembly (23). The applicator hood assembly (23) restricts the application to a particular area of the ground and conserves heat to maintain a heated environment that does not significantly reduce the heat of the hydrothermal treatment fluid in the time that it emits from the applicator nozzle (22) at the outlet of the depressurizing chamber and the vegetation. The applicator hood assembly (23) preferably maintains application and heat for a duration that can achieve plant destruction.

The applicator head (23) can deliver water at a rate of anything from approximately 2 liters per minute up to approximately 40 liters per minute, and typically operates at around 5 to 10 liters of water per minute per 50 sq.cm. Larger machines, which produce higher liters per minute output, are suitable for use in larger areas, such as, for example, orchards or other broad acre agriculture. Some applications may also be applicable to road verges, road curbs and gutters and drainage swales and ditches. The provision of the application nozzle (22) and the depressurizing chamber allow delivery of hotter steam and hot water than would typically be possible without maintaining water in a pressurised state. However, by depressurizing the water just prior to application to the vegetation, a superheated/saturated steam moisture can be created ultimately improving the efficiency of the system and reducing the amount of water required to control vegetation.

The tracking system (10) of some preferred and some alternative embodiments includes a assembly allowing the application system (20) to maintain (in some such embodiments, automatically) a preferable or pre-determined distance from the ground so that a mixture of saturated steam and boiling water is applied to vegetation beneath the applicator hood assembly (23).

In one particular embodiment, which does not have a particular specific illustration in the figures, the applicator head (21) includes a nozzle (22) for creating saturated steam and boiling water. The application ahead assembly (21) includes an input feed tube, along which superheated water is pumped under pressure from the heat exchanger. Typically, the input feed tube is a cylindrical tube having an annular cross section. In one example, the input feed tube has a 12 mm inside diameter and is manufactured from stainless steel that is capable of operating at water pressures in excess of 150 bar. Located inside the tube of the applicator head (21), close to one end of the tube, is a restriction nozzle, which constricts flow of water from the tube. This restriction maintains the pressure of the water between the nozzle and the heat exchanger. The internal diameter of the nozzle may be varied depending on the desired water flow rate and pressure required. In the one example of this particular embodiment, the aperture has a diameter of 1.0 mm, but may vary between 0.5 mm and 5.0 mm depending the application. Adjacent the restriction nozzle is a depressurizing chamber. In one example, the chamber is a rectangular or cylindrical like chamber having an increased diameter relative to the diameter of the input tube. The volume of the chamber is not critical as long as it is a larger volume than the volume of the water that the restricting nozzle can release. The chamber may be manufactured from any material, which is capable of sustaining water pressures in excess of 52 bar and temperatures of up to 200° C., stainless steel being one example of a suitable material. An outlet having a size from 2 mm to 10 mm, and being larger than the aperture defined by the nozzle, preferably at least twice the diameter, from the depressurizing chamber is in fluid communication with a distribution applicator. The distribution applicator defines a series of ports or holes, having a diameter of 6 mm but which may be varied to suit the volume of water flow required and may typically range from 3 mm to 15 mm in diameter. In one example, the distribution applicator comprises a hollow cylindrical tube made from a malleable non-corrosive material with a number of holes for application of the superheated steam. The number and size of the delivery holes is matched to suit the water flow ensuring that no backpressure is created. The distribution applicator can be made into any desired shape to suit different applications, such as a sphere, hemisphere, a polygon, or other shape. Boiling water and saturated steam lose temperature quickly at ambient atmospheric pressure and temperature, reducing efficacy and productivity in vegetation control. Hydrothermal vegetation control has been limited in its application to concentrated delivery onto relatively small application widths of from around 5 cm to around the 60 cm typically and some fewer applications up to around 90 cm. These limitations are attributable to the lost efficacy as the size of the applicator system (20) increases due to the heated treatment fluid, i.e., superheated steam and boiling water, being spread over a larger area reducing the intensity and efficacy of the fluid delivered to the vegetation. However, applicator heads (21) and hoods (23) designed to build up and maintain internal temperature at a level close to 100° C. increase the efficiency of the superheated treatment fluid being applied.

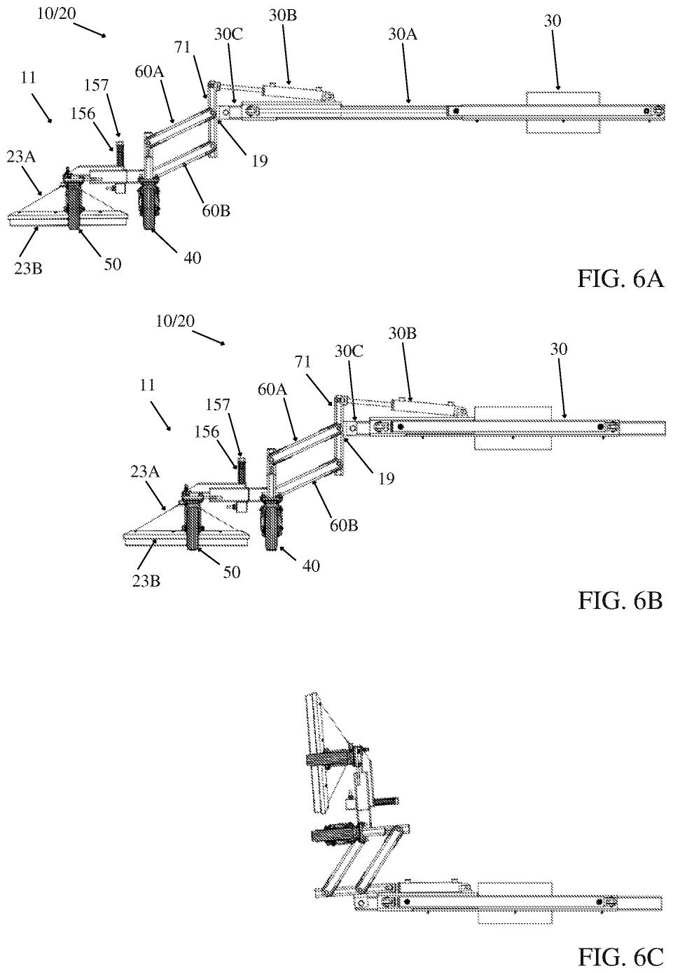

A short overview of some embodiments the electronics that can be adopted for delivery of hydrothermal treatment solution is as follows: A power system includes a generator and/or a battery. As shown in FIG. 6, the generator has a 3-phase output. A nonpolarized line from each stator of the generator is connected to a three-terminal input of a voltage controller. The controller may include a 3-phase rectifier circuit and smoothing and filter circuit to convert the AC output from the generator to DC power. In one example, the output from the hybrid controller is 13V. In another example the output is provided by the alternator of the vehicle of hydrothermal application system. In this configuration, the generator is not required as the power is supplied from the vehicle. The voltage controller also is grounded. The controller also includes a positive and a negative output terminal. The positive output terminal is connected to a meter, a fuel solenoid, a burner fan motor, an ignitor, and primary control circuit. The primary control circuit allows control of the fuel solenoid, the burner fan motor, the ignitor. The fuel solenoid is activated to power on the pump-to-pump fuel to the burner. The ignitor is powered to spark and ignite the fuel. The burner burns the fuel and the generated heat is directed to the heat exchanger coil by the burner fan. A temperature thermostat switch, a flow switch, and a pressure switch are connected to the primary control. The flow switch controls actuation of an inline circuit switch located in a line from the pump to the heat exchanger. The flow switch is activated when a flow is detected and cut when the flow is stopped. For example, when the system reaches the end of a run (e.g., at the end of a row in a vineyard), the flow of water can be ceased using a manual ball valve or electronically controlled in line actuator valve and the flow switch turns off and the burner shuts down. This combination can conserve water and fuel, and prevent the water in the heat exchanger coil to continue being heated. The temperature thermostat switch prevents the burner from operating over a recommended temperature. The pressure switch requires a predetermined pressure (e.g., 500 psi) to switch on and allow the burner to ignite and stay alight and stops the burner from staying alight when there is insufficient water in the coil, or the water pressure drops due to lack of supply. The meter may be an hour meter to measure total time of usage of the system and program servicing and maintenance. An optional float switch also may be included (not shown) to switch off the heat exchanger and/or pump if there is low water reading in the tank.

A burner main switch completes the circuit. The burner main switch is activated to allow the burner to be able to ignite if there is water flow and sufficient water pressure.

Although the preceding embodiment illustrates use of a heat exchanger, other means of heating the water can be used. For example, any type of thermal coupling of the water to a heat element may be used. In one example, an induction heater may be used to remove the need for a fuel using electricity to heat the water instead.

### Chemical Treatment Fluid Application

FIG. 1C provides a schematic diagram of the system according to one embodiment which is adapted to deliver chemical treatment fluid for vegetation control.

Positioned on the mobile frame (110) in embodiments wherein the application system (20) is adapted to provide chemical treatment fluid are, for example, a tank, a pump, a regulator, and a gauge as well as pipes and/or hoses connecting these elements in a suitable configuration for the chemical treatment fluid to be transferred from the tank through to the application system (20) for delivery to vegetation.

The tank may be of any type that can be filled (via, for example, a filling element, such as, a cap) with a liquid aqueous chemical solution (e.g., fertilizer, pesticide, herbicide, fungicide, or other chemical(s)) that is applied by one or more spray nozzles (22) of the application system (20). Various sizes may be provided based on the chemical applied and/or the amount of terrain or vegetation serviced by the application system (20). The mixture in the tank flows from the tank through a line, in some embodiments, having a filter, to remove any particles that might plug any orifice in the system (e.g., the nozzles (20)). Alternatively, or in addition, the tank may be fitted with such a filter. After passing the filter, the fluid solution travels through the pipe or the line to a pump. One of several types of pumps may be used, depending on the desired flow (litres/min) and the pressure (bar) required by the system for any particular application. In one example, the pump can be driven by a power take off from the vehicle (100) or by a hydraulic motor. In other examples, the pump may be an electrical pump driven by a battery, a generator, or power tapped from the vehicle's (100) electrical system.

In one example, the chemical solution flows from the pump along a pipe or a line to a pressure regulating valve. In addition, a portion of the flow from the pump may be returned to the tank by a siphon line and a control valve and unloader, for example, to agitate the solution in the tank or control the flow rate to the spray nozzles (22). Agitation may be desirable to prevent the chemicals and other materials in the solution from separating and/or settling in the tank. Any excess flow produced by the pump also may be returned to the tank via a by-pass line from the pressure regulating valve or unloader. The fluid solution is pumped from the regulation valve along a line or a hose to the spray applicator of the application system. Along the line, a connection is made for a pressure gauge to allow an operator to monitor and/or adjust the system flow and/or pressure. An optional selector valve may be provided to direct the flow of the mixture to the different spray nozzles (22) depending on the system configuration.

One skilled in the art will appreciate that various application rates may be used depending on the particular chemical solution and/or application. The application rate is determined according to the following standard equation:

$$Application rate R ( L / ha ) = \frac{Flow rate of nozzle ( aka rate of discharge ) Q ( L / min )}{Nozzle spacing w ( cm ) \times vehicle travel speed ( nozzle ) v ( km / h )} \times 60000$$

The tracking system (10) of some preferred and some alternative embodiments includes a mechanical assembly allowing the application system (20) to maintain (in some such embodiments, automatically) a preferable or pre-determined distance from the ground so the sprayed or delivered chemical solution is confined beneath applicator hood (23), and spread of the sprayed chemical solution to undesired areas is preferably minimized. In addition, the amount of chemical solution needed for any one particular application may be reduced, for example, because drift, dilution, and other factors are preferably controlled, minimized, and/or eliminated.

In embodiments that are adapted to deliver a combination of hydrothermal treatment solution and chemical treatment solution, suitable permutations and combinations of the component parts described above can be enclosed within the mobile frame housing (114).

### Overall Architecture of the Disclosed System

More broadly with reference to FIG. 1, viewed from the front of the tractor (100) and facing the trailer (110), the tracking system (10) seen on the left is extended in a ground engaging configuration (11). The connection of the tracking system (10) seen on the left to the trailer (110) is effected through a boom extension (30) which is interposed between the portion of the side of the trailer (110) and tracking system connection means (19). Boom extension (30) is adapted to enable a greater distance to be achieved between the tracking system (10) and tractor (100), trailer (110), and/or or other device (typically, but not necessarily, mobile and/or power driven) than for embodiments of the invention in which the tracking system (10) is directly connected to the tractor (100), trailer (110), and/or other device via the tracking system connection means (19).

Boom extension (30) is adapted to be movable between a retracted configuration (31) and an extended configuration (32), wherein in the extended configuration (32), the distance between the tracking system (10) and tractor (100), trailer (110), and/or other device is greater than when the boom extension (30) is in the retracted configuration (31) or otherwise between the extended configuration (32) and the retracted configuration (31).

Viewed from the front of the tractor (100) and facing the trailer (110), the tracking system (10) seen on the right is in a home configuration (12). In the embodiment depicted in FIG. 1, when the tracking system (10) is in the home configuration (12), the application system (20) is inactive. Persons skilled in the art will, however, appreciate that there may be some circumstances where the positioning of the application system (20) when the tracking system (10) is in the home configuration (12) is such that it can be used for, for example, attending to vegetation control of vegetation on a wall or other vertical surface. For those circumstances, the application system (20) is not inactive just because the tracking system (10) is in the home configuration (12).

### The Tracking System

The tracking system (10) of some preferred embodiments includes two or more tracking wheels or tracking skids, or tracking rollers that contact the ground, an articulating frame (14), a pivoting frame (15), and a self-adjusting arm (16). In the following described example, the tracking system (10) includes tracking wheels (13). At least one first tracking wheel (13) is attached to a base member (17) of the articulating frame (14) to position and maintain the articulating frame (14) at a predetermined or preferred distance from the ground and to track alongside, for example, the vehicle (100) or mobile frame (110). In one embodiment the tracking system (10) includes two first wheels (13) attached to the base member (17) of the articulating frame (14). At least one second wheel (13) is attached to the pivoting frame (15). The second wheel (13) of preferred embodiments automatically positions and maintains the application system (20) at a predetermined or preferred distance from the ground. In addition, the second wheel (13) can also, preferably automatically, adjust the pivoting frame (15) to maintain the preferred distance even as the ground elevation varies allowing the application and tracking systems (20 and 10) to accommodate terrain with varying elevations. The self-adjusting arm (16) is attached to the pivoting frame (15) and adjusts the position of the application system (20) to accommodate obstacles in the path of the application system (20). For example, the self-adjusting arm (16) allows the application system (20) to move around, or be moved by, vegetation, such as trees, vines, and larger plants, in addition to other obstacles, such as poles, roadside posts, fencing, rocks, and other obstructions contacted by the insulating hood (23) and in the path of the application system (20). In some preferred embodiments, when the self-adjusting arm (16) allows the application system (20) to ‘move around’, or ‘be moved by’ such obstacles, the self-adjusting arm (16) so allows such movement of the application system (20) minimizing or avoiding damage to either the application system (20) or the obstacle.

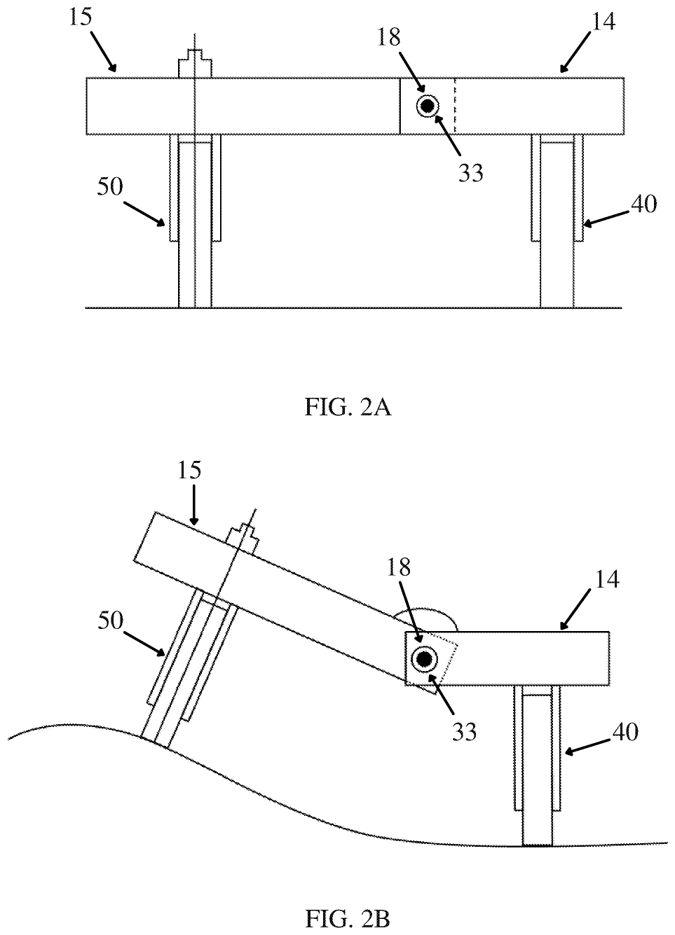

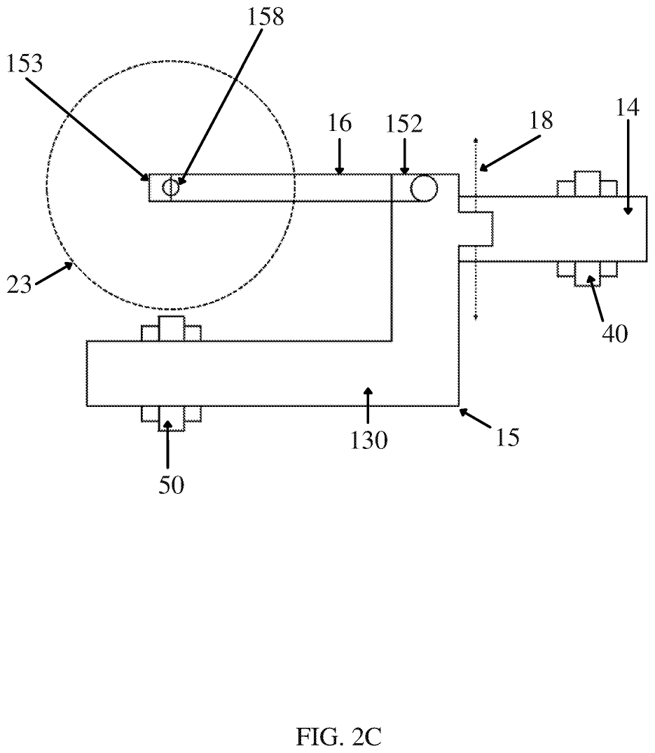

FIGS. 2A, 2B, and 2C illustrate various components of tracking system (10) of some preferred and some alternative embodiments. Components of the tracking system (10) depicted in FIGS. 2A-2C include an articulating frame (14), a pivot axis (18), a pivoting frame (15), a first ground tracking device (40) and a second ground tracking device (50). In one example, the first ground tracking device (40) is a first wheel (13) and the second ground tracking device (50) is a second wheel (13). The first ground tracking device (40) is attached to the articulating frame (14) and the second ground tracking device (50) is attached to the pivot frame (15). In another example, the first ground tracking device (40) may include two first wheels (13) to provide extra support and/or stability to the tracking system (10). The articulating frame (14) attaches to one or more articulating arms (not shown in FIGS. 2A-2C) allowing the tracking assembly (10) to be attached, fitted, and/or secured to a vehicle (100), a trailer (110), or other machinery transporting the tracking system (10). The articulating arms (60) allow the articulating frame (14) to move alongside, in front of or behind a vehicle (100) or a mobile platform (110) and adjust for changes in ground elevation alongside the vehicle (100) or mobile platform (110) as the vehicle (100) moves over terrain.

The pivoting frame (15) positions the application system (20) to maintain a predetermined or a preferred distance from the ground so that a hydrothermal treatment solution, chemical treatment solution, or a combination thereof, sprayed from the nozzle of is applied to vegetation beneath the hood assembly (23).

The pivoting frame (15) and the articulating frame (14) are joined along the pivot axis (18) at or adjacent pivot point (33). The pivoting frame (15) can pivot or rotate about the pivot axis (18) and relative to the articulating frame (14).

In some embodiments, the core element (80) of the articulating frame (14) includes core element holes adapted to receive bushings and/or bolts or pins, enabling, for example, the ‘pivoting’ movement is, in some preferred and alternative embodiments, only one form of relative movement between the pivoting frame (15) and the articulating frame (14). For example, several preferred and alternative embodiments disclose that the ‘join’ between the pivoting frame (15) and articulating frame (14) is also formed through a hole section (70), such as a square or rectangular hole section, through which at least a portion of the core element (80) of the articulating frame (14) freely slides in either direction (up and down). This configuration for the tracking system (10), permitting ‘free sliding’ movement of at least a portion of the core element (80) of the articulating frame (14) through the hole section forming part of the ‘join’ between the pivoting frame (15) and the articulating frame (14) provides at least a second form of relative movement between the gifting frame (15) and the articulating frame (14). For some of these embodiments, the pivot axis (18) is formed through the connection between mounting member extension tabs (72) (with mounting member holes (73)) and pivot point tabs (140) (with pivot point tab holes (141)) by bushings and/or bolts or pins passed through the mounting member holes (73) and the pivot point tap holes (141). In some of these embodiments, the bushings, bolts or pins are selected, possibly together with other items such as washers or circlips so that no element of any bushing or bolt or pin extends through the core element, not even via core element holes (143) (which, for such embodiments, the core element holes (143) are unnecessary). Other embodiments in which the bushings, bolts or pins also extend through the core element holes (143) are discussed in more detail further below.

As the first ground engaging device (40) tracks along the ground, the first wheel (13) maintains the elevation of the articulating frame (14) above the ground and allows the articulating frame (14) to travel along and track the ground nearest the vehicle (100) or mobile platform (110) while attached, fitted or secured to the vehicle (100) or the mobile platform (110) via the articulating arms (60). The second ground engaging device (50) also tracks along the ground, and the second wheel (13) to maintains the pivoting frame (15) a predetermined or preferred distance above the ground. In some preferred embodiments, the distance that the second wheel (13) maintains the pivoting frame (15) above the ground is selected so as to position the application system (20) at a predetermined or preferred distance above the ground so as to preferably create and preferably maintain an environment to control vegetation. In one example, the second ground engaging device (50) and the application head assembly (when he won) of the application system (20) are arranged along an alignment line of travel. In this configuration the second wheel (13) is aligned with and tracks the path of the the spray nozzle (22) of the application head assembly (20).

FIG. 2A shows the tracking system (10) on level ground. In this example, the first ground engaging device (40) and the second ground engaging device (50) are each located on ground having substantially the same elevation. FIG. 2B shows the tracking system (10) on ground having varied elevation. As shown in FIG. 2B, the first ground engaging device (40) maintains the articulating frame (14) at a first elevation. The second ground engaging device (50) maintains the pivoting frame (15) at a second elevation. As elevation changes (for example along mounded rows of trees, plants, or vines), the second ground engaging device (50) causes the pivoting frame (15) to pivot or rotate about the pivot axis (18) forming an angle between the pivoting frame (15) and the articulating frame (14). Preferably, the application system (20) is therefore able to preferably automatically track, adjust, and accommodate sloped terrain, such as mounding rows found in orchards and farms. FIGS. 2A and 2B illustrate basic principles of the tracking system and additional parts, features, and embodiments are described in further detail below.

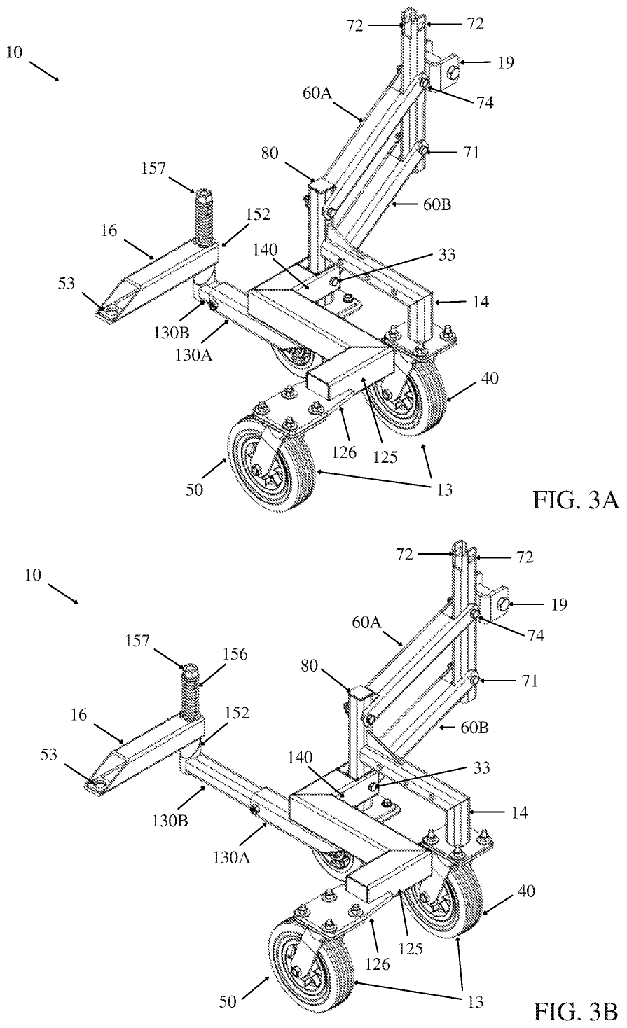

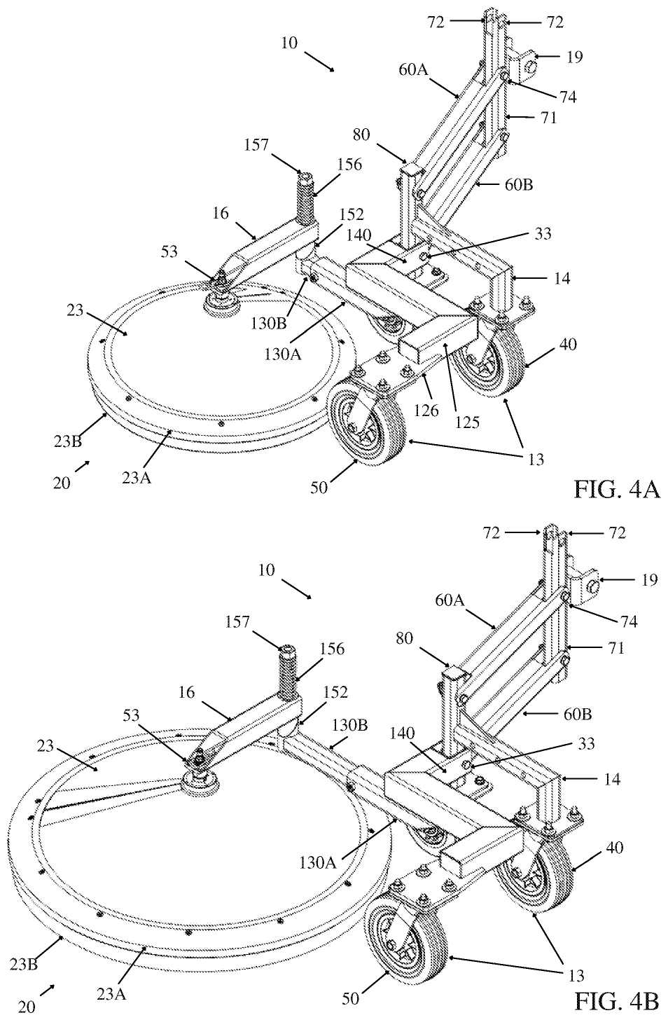

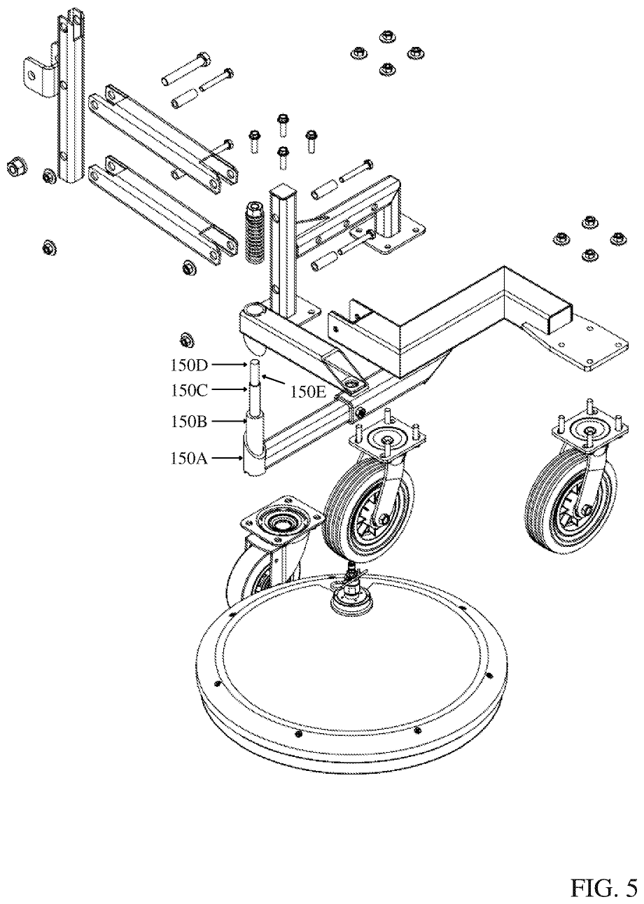

FIGS. 3A, 3B, 4A, and 4B show two different configurations of a tracking system (10) according to one preferred embodiment of the invention, with FIGS. 4A and 4B each further illustrating an application system (20) according to one of two preferred embodiments of the invention loaded/engaged with the tracking assembly system (10) depicted. FIG. 5 is an exploded view showing component parts of a tracking system (10) and application system (20) assembly shown in FIGS. 3A-3B.

In light of the following description being directed to a tracking system (10) and application system (20) assembly, some of the text that follows may refer to the same as a tracking and application assembly system, conveniently initialized as TAAS (10/20). The TAAS (10/20) of preferred and alternative embodiments include a mounting member (71) which, in the embodiment depicted is shown as a vertical post, is adapted to engage through tracking system connection means (19) with a portion of a vehicle (100), a trailer (110), or other equipment transporting the tracking system (10) or, in some preferred and alternative embodiments is adapted to engage with a distal end of a boom extension (30). In some preferred embodiments, the tracking system connection means (19) is provided by a “C”-shaped mounting bracket and bushing (not shown). The mounting bracket (19) is used to attach the TAAS (10/20) to equipment (100/110) transporting the TAAS (10/20) by inserting of a pin (not shown) through the bushing to mount the TAAS (10/20) on such equipment (which could also include, being attached to a support arm (not shown) of the vehicle (100) or of a mobile platform (110)). In some embodiments, the vertical post (71) includes two mounting member extension tabs (72) with mounting member holes (73) to provide more robust attachment to, or an additional mounting point for attaching, the TAAS (10/20) to machinery (100/110) by bolting.

The vertical post (71) also includes attachment points (74) for at least one articulating arm (60). In preferred embodiments, at least two articulating arms (60) (upper and lower) are attached at their respective proximal ends (61) to the attachment points (74) on vertical post (71). The articulating arms (60) of several embodiments have a “U”-shaped cross section on each of their proximal end (61) and distal end (62) which includes a cut out or slot formed by two articulating arm tabs (75) (each of which being a side of the “U-shape”) and each with a hole (76) for receiving securing pins (77) inserted though the holes (76). Some preferred and alternative embodiments disclose that the tabs (75) at the proximal end (61) of each of articulating arm (60) are separated by a width slightly greater than the width of the vertical post (71). This width permits the tabs (75) to overlap outer sides of the vertical post (71) and align with corresponding holes formed in those outer sides of the vertical post (71). Securing pins (78) are preferably inserted through the holes (76) to mount the arms (60) on the post (71). The distal end (62) of each articulating arm includes a similar slot, cutout, and holes formed through similar tabs (75) to corresponding holes formed in outer sides of a portion of the articulating frame assembly (14), also via pins (77). The proximal end (61) and distal end (62) of each articulating arm (60) are, when so mounted according to some preferred and alternative embodiments, free to pivot at the pins (77) to form a variable parallelogram by expanding and contracting in a first vertical plane.

### Articulating Frame Assembly

The articulating frame assembly (14) of some embodiments includes:
a core element (80) which, in some preferred and some alternative embodiments, takes the form of a vertical main post, preferably including core element mounting means (82) attached or adjacent to its lower end (81) for mounting one first ground tracking device (40a) which, in some preferred and some alternative embodiments, takes the form of a wheel mounting platform; and
an optional stabilizing element (83) which, in some preferred and some alternative embodiments, takes the form of a horizontal beam, preferably including stabilizing element mounting means (85) attached or adjacent to its outer end (84) for mounting another first ground tracking device (40b) which, in some preferred and alternative embodiments, takes the form of a wheel mounting platform.

In some preferred and alternative embodiments in which a stabilizing element (83) is included, the inner end (86) of the horizontal beam (83) is connected (for example, by a weld joint) to a side or side surface of the vertical main post (80) at a position between the lower end (81) of the vertical main post (80) and the upper end (87) of the vertical main post (80), typically around a midpoint between those ends (81, 87), and extends from its inner end (86) to its outer end (84) at an angle to the vertical main post (80). In some embodiments, that angle is approximately 90°.

According to further embodiments, the attachment of the another first tracking device (40b) to the outer end (84) is formed in association with an articulating frame support member (88). In some such embodiments, the articulating frame support member (88) is interposed between the outer end (84) and the stabilizing element mounting means (85). In some preferred embodiments, the articulating frame support member (88) extends from the horizontal beam (83) at an angle of approximately 90°.

The post (71) and the beam (83) are, according to some preferred and some alternative embodiments, formed substantially in a second vertical plane orthogonal to the first vertical plane. In some such embodiments, the connection between the inner end (86) of the beam (83) and the outer surface of the post (71) at approximately midway between the upper end (87) and lower end (81) is such that the beam (83) preferably extends from the post (71) in the second vertical plane along an axis substantially perpendicular to a longitudinal axis of the post (71) and bends down at approximately 90° at the outer end (84), forming a portion that is substantially parallel to the longitudinal axis of the post (71). In embodiments where the attachment of the second ground device (50) to the outer end (84) is formed in association with an articulating frame support member (88) as described above, the approximately 90° angle at which the articulating frame support member (88) extends from the beam (83) results in a similar configuration for the articulating frame (15) according to such embodiments, with the articulating frame support member (88) being substantially parallel to the longitudinal axis of the post (71). In some preferred and some alternative embodiments, the core element mounting means (82) and the stabilizing element mounting means (85) are respectively secured to the lower end (81) and to the outer end (84) with a welded joint. In some such embodiments, the mounting means (82, 85) includes mounting means holes (89) for receiving, for example, bolts to secure a portion, such as a base portion, of a corresponding portion in a ground tracking device (40, 50), such as a caster wheel (13). In some embodiments, the ground tracking devices (40, 50) in the form of, for example, caster wheels (13), preferably are arranged to pivot around an axis parallel to a vertical plane.

### Pivoting Frame Assembly

The pivoting frame assembly (15) attaches to the articulating frame assembly (14) and preferably positions the application system (20) relative to the ground. As shown, the pivoting frame assembly (15) includes:
an application system (20) loading/engaging assembly (90); and
a ground tracking device (50) mounting assembly (120).

Mounting assembly (120) takes the form, in some embodiments, of an arm extending from its proximal end (121) which, in some embodiments, is at or adjacent the pivot point (33) to its distal end (122) where, or adjacent to which, it connects with mounting assembly mounting means (123), preferably for mounting the second ground tracking device (50) which, in some preferred and some alternative embodiments, takes the form of a wheel mounting platform. Preferably, the mounting assembly (120) is configured so that the second ground tracking device (50) is positioned so as to accommodate preferred for use placement of the application system (20) and preferred functional configuration of the TAAS (10/20). In some preferred and some alternative embodiments, the mounting assembly (120) takes the form of an S-shaped arm.

In some such embodiments, the S-shaped arm (120) includes mounting assembly main portion (124). At each end (121 and 122) of the main portion (124) the S-shaped arm (120) turns approximately 90° relative to a longitudinal axis of the main portion (124). The proximal end (121) turns approximately 90° in a first direction in a horizontal plane. The distal end (122) turns approximately 90° in a second direction opposite the first direction in the horizontal plane. The distal end (122) of some embodiments is configured with a slot (125) adapted to receive a tab (126) which tab may, for example, form part of the second ground tracking device (50), thereby providing a mechanism to connect the second ground tracking device (50) with the distal end (122) of the ground tracking device mounting assembly (120). In some embodiments, the tab (126) can be secured in the slot (125) via a weld. In the embodiment depicted in, for example, FIGS. 3A, 3B, 4A and 4B, the tab (126) does not form part of the second ground tracking device (50), rather it is adapted to itself engage the second ground tracking device (50). The tab (126) is generally planer and arranged in horizontal plane and, in some such embodiments, includes tab holes (127) receive bolts or pins for securing a portion of the second ground tracking device (50), such as, for example, an engagement plate/tab of a caster wheel (13). Preferably, the second ground tracking device (50) in the form of a caster wheel (13) is arranged substantially vertically on an axis substantially perpendicular to the horizontal beam (83) or the horizontal plane in which horizontal beam (83) be positioned if included, and parallel to the vertical plane. In addition, a length of the distal end (122) of the ground tracking device mounting assembly (120) and tab (126) is preferably selected such that the attached caster wheel (50; 13) is approximately centered on a line that tracks the application head assembly (21) of the application system (20). In this manner, the application head (21) follows the path of the caster wheel (50; 13) when traveling over terrain.

The loading/engaging assembly (90) of some preferred and some alternative embodiments includes a pivoting frame application system orientation means (130) adapted to orient the application system (20) for loading/engagement into the tracking system (10). The pivoting frame application system orientation means (130), as depicted in FIGS. 3A, 3B, 4A, 4B and 5, takes the form of an external square hollow section (130a), with an internal telescoping extension member (130b).

An external member (130a) having a hollowed segment at least (and may be hollow throughout), in some embodiments taking the form of a hollow square shaped frame member, is preferably attached at or adjacent its outer end (131) along a side, and in some embodiments, an underside, of the mounting assembly main portion (124) substantially parallel to the longitudinal axis of the main portion (124). The hollowed segment in the external member (130a) has, in some embodiments, an inner width and height of square shape, and is preferably sized to accept a substantially correspondingly shaped internal telescoping extension member (130b) through an inner end (132) of the external member (130a). The interrelationship between the external member (130a) and the internal telescoping extension member (130b) is discussed in more detail further below.

Preferably, the proximal end (121) of the S-shaped arm (120) includes substantially parallel pivot point tabs (140) separated by a width slightly greater than a width spanning outer surfaces of the mounting member extension tabs (72) of the distal end (62) of the articulating arm (60) (which width includes a width of the articulating frame (14) core element (80) which, itself, is positioned between the mounting member extension tabs (72)). Each pivot point tab (140) has a hole (141) to receive the pivot bushing, nut and bolt assembly (142). In some preferred and some alternative embodiments, each pivot point tab (140) is fitted over a corresponding mounting member extension tab (72) of the distal end (62) of the lower articulating arm (60b), which in turn is fitted around the core element (80) of the articulating frame (14). The holes (141, 73, 143) of the pivot point tabs (140), mounting member extension tabs (72), and core element (80) are substantially concentrically aligned, and a bushing (142a) is inserted through all of those concentrically aligned holes (181, 73, 143). A bolt (142b) is inserted through the bushing (142a) and secured with a nut (142c) to couple the articulating frame (14) and pivoting frame (15) along a pivot axis (18) extending through the length of the pivot bushing, nut and bolt assembly (142). In some preferred and some alternative embodiments, the pivot axis (18) is substantially orthogonal to the first vertical plane and substantially parallel to the second vertical plane and to the horizontal plane. The pivoting frame (15) pivots and moves about the pivot axis (18) relative to the articulating frame (14) to track varying and uneven terrain found in farms, orchards, and other landscapes, as described above with regard to FIGS. 2A and 2B.

Returning to the pivoting frame application system orientation means (130), in the embodiment depicted in FIGS. 3A, 3B, 4A, 4B, and 5, the internal telescoping extension member (130b) is a square frame member of width and height allowing it to be inserted from its outer end (134) into the external member (130a). The depth of insertion or extent of extraction may be adjusted to accommodate different sized and/or shaped application systems (20). In several embodiments, the component of the application system (20) with the largest plan view footprint is the application hood (23). Typically, therefore, the larger the plan view footprint of the application hood (23), the less the depth of insertion or the more the extent of extraction of the internal telescoping extension member (130b) relative to the external member (130a). FIGS. 3B and 4B illustrate the pivoting frame application system orientation means (130) in an extended state, wherein the internal telescoping extension member (130b) is extracted along full length or near full length out of the inner end (132) of external member (130a). As can be seen by comparing FIGS. 4A and 4B, the plan view footprint application hood (23) is greater for the application system (20) in FIG. 4B than it is for the application system (20) in FIG. 4A. Persons skilled in the art would readily appreciate that increasing the length of the pivoting frame application system orientation means (130) could permit application systems (20) with different shapes and sizes to be loaded/engaged with the tracking system (10) according to the invention. In some embodiments, an eye bolt arrangement (133) is adopted to establish a ‘friction’-based locking system to substantially fix the preferred length of the pivoting frame application system orientation means (130) where the eye bolt (133a) is screwed into a hole (133b) in a wall of the external member (130a) until the end of the eye bolt (133a) is pressed up against an outer wall of the internal telescoping extension member (130b) sufficiently hard to substantially prevent the internal telescoping extension member (130b) from sliding in or out of the external member (130a) without the eye bolt (133a) being unscrewed. In some preferred and some alternative embodiments, once the preferred length of the pivoting frame application system orientation means (130) has been ‘fixed’ in accordance with the discussion above, the application system (20) is engaged/loaded.

The loading/engaging assembly (90) of some preferred and some alternative embodiments further includes at least one self-adjusting arm (16) formed as follows: An application system adjustment facilitating means (150) is connected at or adjacent an inner end (135) of the internal telescoping extension member (130b). That connection may be achieved, in some embodiments, through a weld joint. In some embodiments, the application system adjustment facilitating means (150) takes the form of a finger-like post, with a circular cross-section, and having a longitudinal axis substantially perpendicular to the longitudinal axis of the internal telescoping extension member (130b). The longitudinal axis of the finger-like post (150) is, in some embodiments, substantially parallel to the first and second vertical planes and substantially orthogonal to the horizontal plane. An outer most portion (150d) situated toward the top of the application system adjustment facilitating means (150) may, in some preferred and some alternative embodiments, include a first portion (150b) and second portion (150c) each with a smaller diameter than a base portion (150a) of the application system adjustment facilitating means (150d). In some embodiments, at least the second portion (150c) has a male thread on its outer surface (location of thread identified at 150e).

A self-adjusting arm (16) is adapted to bridge the application system adjustment facilitating means (150) and the application system (20). the self-adjusting arm (16) depicted in FIGS. 3A, 3B, 4A, 4B and 5 is formed of a square frame member extending along a longitudinal axis with a proximal end (152) and a distal end (153). The proximal end (152) includes a hole (154) the diameter of which is adapted to accommodate the diameter of the first portion (150b) of the finger-like post (150). The distal end (153) of the self-adjusting arm (16) includes a hole (155) adapted to receive and secure a nozzle support member (22a) and in some embodiments in which a hydrothermal treatment solution is to be delivered, a high-pressure hose attachment (not shown). In some embodiments, the high-pressure hose attachment is preferably adapted for attachment and detachment with relative ease to bring superheated pressurized water from the heating apparatus to the application system.

The application system assembly (20) also includes a hood assembly (23) or other containment structure that is secured by the nozzle support member (22a). The hood assembly (23) of some preferred and some alternative embodiments surrounds the application nozzle (22) and extends from the nozzle toward the ground to contain under the hood assembly (23): (a) in embodiments adapted to deliver a hydrothermal treatment solution, the heated environment; and (b) in embodiments adapted to deliver a chemical treatment solution, the spread of the chemical solution so as to concentrate the solution on the surface or ground. The hood assembly (23) of some embodiments typically includes a generally conically-shaped member (23a), a sealing strip/fitting means (not shown), a cone top fixture means (not shown), a support/cylinder rotary connecting means (not shown), a bumper ring (not shown), a brush and/or skirt (not shown), and various fasteners (not shown) for interconnecting relevant components.

The application nozzle (22) is preferably secured at or adjacent a top of the cone by the support cylinder/rotary connection means. While a generally conically-shape for the applicator hood (23) is depicted, other shaped hoods and containment structures may be used, such as, for example, pyramidal, cylindrical, and spherical, just to name a few. The nozzle support member (22a) and, in some embodiments, the support/cylinder rotary means is/are preferably adapted to allow the hood assembly (23) to rotate within a center axis of the cylinder (e.g., when contacting obstacles). The nozzle support member (22a) of some embodiments may also be used to adjust the height from the ground of the hood assembly (23).

A preferred length for the self-adjusting arm (16) is determined such that distal end (153) approximately centers the applicator nozzle (22) with the with a central axis of the second round tracking device (50) (taking the form of a caster wheel in FIGS. 3A, 3B, 4A, 4B, and 5) along a direction a travel parallel to the horizontal and second vertical planes. As mentioned above, the self-adjusting arm (16) is preferably positioned to bridge the application system adjustment facilitating means (150) and the application system (20). In some preferred and some alternative embodiments, the proximal end (152) of the self-adjusting arm (16) is positioned on the application system adjustment facilitating means (150) (taking the form in the embodiment currently being described of a finger-like post), with the fingerlike-post (150) inserted through the hole (154) in the proximal end (152) of the self-adjusting arm (16) until an underside of the self-adjusting arm at or adjacent the proximal end (152) rests on the base portion (150a) of the finger-like post (150).

A spring member (156) has, in some preferred and some alternative embodiments, has, a coil with a pitch that corresponds to, or can readily deform to correspond to, a pitch of the thread on the second portion (150c) of the application system adjustment facilitating means (150). Preferably, the spring member (156) is placed over that part of the finger-like post (150) which protrudes above the proximal end (152) of the self-adjusting arm (16) resting on the base portion (150a) and, in embodiments of the second portion (150c) of the finger-like post (150) which have a thread (at 150e) on its outer surface, is wound onto that threaded surface. In some preferred and some alternative embodiments, a spring securing nut (157) is screwed onto an upper portion of the threaded surface of the second portion (150c) of the finger-like post (150). In some embodiments, when the spring securing nut (157) is screwed onto the upper portion of the threaded surface, the spring member (156) is configured into a tensioned state, with the spring member (156) tensioned against the self-adjusting arm (16) at or adjacent its proximal end (152).

The self-adjusting arm (16) extends from the finger-like post (150) arranged in its neutral position with its longitudinal axis substantially parallel to the first vertical plane and substantially orthogonal to the second vertical plane when the spring member (156) is initially tensioned as the spring securing nut (157) is screwed onto the upper portion of the threaded surface (at 150e) of the second portion (150c) of the finger-like post (150). The self-adjusting arm (16) is adapted to swing under tension of the spring member (156) in a plane substantially parallel to the horizontal plane. The self-adjusting arm (16) is able to swing and/or rotate about the longitudinal axis of the finger-like post (150). This allows the applicator hood (23) and the applicator head (21) to “swing back” so that the hood (23) can move around posts, trees, and other obstacles upon impact of the hood (23) with such obstacles as the system moves across various terrain. After passing the obstacles, the spring member (156) recoils until the self-adjusting arm (16) to its original neutral position. In some embodiments, a flexible skirt or brushes (23b) extend from the underside (or underside of a circumference) of the hood (23) provide for further adaptation of the system to less significant local changes in surface or ground elevations that would not otherwise result in the tracking system (10) adjusting its position or configuration. The flexible skirt or brushes (23b) can also provide additional containment of any sprayed solution to the immediate environment beneath the hood (23).

In general, the frames and arms may be formed from hot rolled steel (e.g., HR 250) and powder coated for corrosion resistance.

FIGS. 6A to 6C are side views illustrating progressive change of the TAAS (10/20) from a relatively extended and active configuration to a relatively retracted configuration. In some preferred and some alternative embodiments, the extended and active configuration is suitable for use with vegetation control on a horizontal surface such as the ground, with the tracking system (10) in the ground engaging configuration (11). In some preferred and some alternative embodiments, when the TAAS (10/20) is in a retracted configuration, with the tracking system (10) in the home configuration (12), the application system (20) is inactive. As discussed earlier, however, persons skilled in the art will readily appreciate circumstances in which having the application system (20) active while the TAAS (10/20) is in a retracted configuration is appropriate/required. One such circumstance would be, for example, one in which vegetation control is being applied to a vertical surface, such as a wall. The home configuration (12) can also provide additional manoeuvrability for an operator, for example, allowing movement through gates and such.

Depicted in FIGS. 6A to 6C is an embodiment of the invention in which a boom extension (30) is connected to the tracking system connection means (19) such that, in use, the boom extension is interposed between the TAAS (10/20) and a vehicle (100), a trailer (110), or other machinery transporting the TAAS (10/20). In some preferred and some alternative embodiments the boom extension (30) allows an operator to position the TAAS (30) for a particular application, such as terrain where vegetation control is being performed or for reaching areas greater or lesser distances from the vehicle (100). The boom extension (30) of some embodiments includes an boom extension arm (30a) and a boom extension actuation means (30b). The boom extension arm (30a) may take the form of a support beam. The support beam (30a) is used to mount the tracking assembly (10) to a vehicle (100) or frame assembly (110). For example, the support beam arm (30a) may be mounted at the front, the middle/side of the vehicle (100), or the rear of the vehicle (100), or at any of these locations on a trailer (110), or other machinery transporting the TAAS (10/20). In relation to the connection of a distal end (30c) of the boom extension (30) to the tracking system connection means (19), the distal end (30c) is preferably formed having a width slightly smaller than the distance between tabs forming the tracking system connection means (19) of the mounting member (71). In addition, the support beam arm (30a) may include two holes at the distal end (30c) which are preferably aligned to receive a bushing and mounting bolt that is inserted through the corresponding holes in the mounting member (71).

In one example, the actuator means (30b) is a linear actuator. The linear actuator converts rotational motion of its motor and gears into linear or straight push/pull movements. In one example, the linear actuator is an electric linear actuator, such as the LINAK™ LA36. The actuator includes an internal motor and gears (not shown) in a housing linked to a piston rod. One end of the base of the housing of the actuator is, in some preferred and alternative embodiments, attached to an upper surface of the support beam arm (30a). The piston rod includes an eye hole at an exposed end of the piston rod. The eye hole is preferably aligned with holes formed in two extension tabs at or adjacent a top surface of the mounting member (71). A bolt is inserted through the holes and eye hole to couple the rod to the TAAS (10/20). Activation of the rod causes force to be applied to the top of the mounting member (71) causing the mounting member (71) to pivot around the bushing at tracking system connection means (19) coupling the support beam arm (30a) to the mounting member (71). Although the actuator means (30b) is described and pictured as mounted on top of the support beam arm (30a), in another example the actuator means (30b) can be mounted on the bottom of the support beam arm (30a). In this configuration, the two extension tabs of the mounting member (71) are formed an opposite end to couple with the eye of the rod. In another example the actuator means (30b) can be doubted on a side of the support beam arm (30a) with suitable adjustments to the two extension tabs of the mounting member (71).

The support beam arm (30a) on which the actuator means (30b) is mounted may also be formed with telescoping extension, such as, for example, by being received into a receiving member having at least a hollowed portion (it may be hollow along the entire length of the receiving member) (not shown) enabling a preferred or pre-determined length for the boom extension (30) to be fixed manually. In another example, the support beam arm (30a) is connected to the receiving member with a 2nd actuator means or hydraulic piston arm that allows for the adjustment of the support beam arm (30a) relative to the receiving member, enabling a preferred or pre-determined length for the boom extension (30) to be fixed electronically or automatically.

The support beam arm (30a) can also be mounted directly onto the side, front or rear of a vehicle (100), trailer (110), or other machinery transporting the TAAS (10/20), for example, using one of a mounting spigot or bar. In another example, the support beam arm (30a) may be mounted on a hydraulically controlled assembly, which gives the operator ability to control height, width and or an angle deviating from the horizontal plane.

As discussed above, FIG. 1 illustrates the tracking system (10) (and TAAS (10/20)) on either side of a tractor (100)/trailer (110) arrangement, wherein when viewed from in front of the tractor (100) looking back at the trailer (110), the TAAS (10/20) on the left is in the fully extended and ground engaging configuration (11) and the TAAS (10/20) on the right is in the fully retracted and home configurations (12).

The application assembly (20) includes an applicator head (not shown) and a hood assembly (23). The spray application may be implemented using any one of various spray nozzles based on the application or solution used for any particular treatment or regiment. In some embodiments, spray nozzles typically include an inlet and/or chamber, which receives the solution from the line connected to the pump and the tank. The nozzle (22) may include threads (not shown) on a portion of the outer surface to allow the nozzle (22) to be inserted and removed. In other configurations, the nozzle (22) may be shaped to allow hoses to be quickly attached and disconnected, generally in form of quick connects that mate with a high-pressure hose having a corresponding connection. The nozzle (22) also includes a restriction having a narrower diameter than the inlet, which is sometimes additionally shaped with a notch or other restriction to shape the distribution pattern of the sprayed solution emitted from the nozzle. Various nozzles (22) have different examples of a corresponding common spray pattern. One skilled in the art will appreciate that the nozzle (22) can come many different shapes and sizes, wherein the actual nozzle used in any one application is dictated by the solution and/or application desired, as can be readily ascertained by those skilled in the art.

In addition to the nozzle (22) the application system assembly (20) includes a containment structure to limit spread and/or concentrate delivery of a sprayed solution onto a desired application area or environment. In one example, a shroud or a hood (23) is placed around the applicator head/nozzle to focus, concentrate, or otherwise minimize spread of the solution to undesired areas.

The hood (23) of some preferred and some alternative embodiments may be fabricated from, steel, stainless steel, aluminum, molded plastic, a composite structure, for example, with an insulator, such as, plastic, and a metal, such as steel. The hood (23) is preferably formed to retain (a) and build up heat inside the hood at a desired temperature for controlling vegetation (e.g., at 100° C. or higher); (b) the chemical solution in the environment immediately below or inside the hood; or (c) both. An additional close-fitting cover may be placed over a plastic hood fabricated of a lightweight insulation material encased and sewn into a high strength waterproofed fabric. Various hoods (23) may include shapes with low profiles (e.g., to position distribution applicators approximately 10 cm from the ground, for example, Satusteam™) and in some applications designed to move easily around obstacles, minimize internal volume, and, for embodiments which thermal treatment solution is to be applied, are fabricated from materials that preferably maximize heat retention within the hood.

For embodiments in which thermal treatment solution are to be a applied, the hoods (23) preferably provide an operating environment temperature above at least 98° C. within the hood (23), being a temperature that is preferred for treating unwanted vegetation and plant cell destruction. Productivity can decrease rapidly at delivery temperatures below 98° C., and surface vegetation can recover even with brief exposure to moisture below 90° C. One example of an average operating temperature (which varies with atmospheric conditions, air temperature, and ground temperatures) is 118° C. In addition, in one example, a volume of 5 L per nozzle (22) per 50 cm×50 cm surface area is preferred for delivery by such hood (23) and nozzle (22) combination. In addition, it is preferable to provide a lightweight hood that maintains good structural integrity when operating in this temperature range and that has low manufacturing costs.

A particular embodiment for a hood (23), which does not have specific illustration in the Figures, includes a conical member (23a), a sealing strip/fitting, a cone top fixture, a rotary connection, a bumper ring, a brush and/or skirt (23b), and various fasteners.

The conical member (23a) comprises a single sheet with two main surfaces and four edges. Two of the four edges are parallel and the remaining two of the edges are nonparallel. The sheet is fabricated using a composite metallic and insulating material, such as plastic, which provides the benefits of minimal weight that is workable in a manufacturing sense (e.g., easily bent, cut, rolled, curved within hood design parameters) while providing excellent insulating, structural and durable properties. In another example, the sheet may be formed out of steel or other metal. In another example, the conical member (23a) may be formed out of injection molded plastic (e.g., Polyethylene) forming one continuous member. These panels are lightweight but mechanically strong, resilient, and durable even in extreme or harsh operating environments experienced by the hood (23), including high temperatures and pressures. In addition, these panels can provide insulating properties designed to keep operating temperatures under the hood over 98° C. (e.g., 100° C.).

In some preferred embodiments, the panels are cut to a desired size and folded such that the non-parallel edges meet thereby by forming a cone of the desired volume and height (e.g., to position the steam applicator heads (21) around 10 cm above the ground). The conical curvature may be selected to align with the spray pattern of any particular nozzle. In one example, the conical curvature may be between 20-40°. Although a conical hood (23) is depicted in the Figures, shrouds and hoods (23) of other shapes and designs may be used. For example, other shaped hoods (23) and containment structures may be used that are capable of containing, concentrating, or otherwise mitigating spread for the solution dispersed by the applicator head (21), such as pyramidal, cylindrical, and spherical shapes, just to name a few.

Once folded, the conical member (23a) is inserted into a bumper ring. The bumper ring may be formed of a molded plastic (e.g., Polyethylene). In addition, a sealing strip member may be applied to the conical member (23a) between the nonparallel edges to seal any gap formed where the edges of the conical member meet. The sealing strip has a length approximately equal to a width of the sheet panel of the conical member (23a). The sealing strip has an H shaped cross section forming two parallel notches or channels that run along opposite sides of the strip. Each channel has a width to receive the nonparallel edges of the sheet with a friction fit. In addition, an adhesive may be placed into the channels to secure the edges and the strip. The shape of the conical member (23a) is maintained by the multi-purpose bumper ring to ensure the base of the cone base remains circular and to function as a bumper-wheel that rolls the applicator hood (23a) around posts, trees, and other obstacles. The bumper ring includes a thinner, planer portion or flap formed at an acute angle to the thicker base portion (e.g., at an angle to mate with the conical angle of the conical member). The flap overlaps the outer surface of the panel at the base of the conical member (23a). This flap may include a number of holes spaced apart at various intervals adapted to accept fasteners (e.g., countersunk stainless screws approx. M6 with washer and Nylex locknuts) to attach and hold the bumper to the panel. In addition, the thicker ring portion provides strength to the structure and protects the conical member (23a) from damage. The thicker ring portion includes a channel formed in the base of the ring. The channel is a holder for a replaceable brush and/or skirt (23b) that may be inserted into and removed from the channel. The brush (23b) is secured by a mechanical and/or friction fit. The brush (23b) helps minimize wear and tear of the hood (23) being operated close to the ground and helps minimize disruption of hood (23) alignment from minor obstacles or ground anomalies. In one example, the brush (23b) may be formed of an extruded flexible back strip with brushes extending therefrom. In addition, the skirt (23b) helps contain sprayed solution and prevent drift or undesired application. The strip may be formed by fusing high quality brush filaments into an extruded backing (e.g., a 3.2 mm, a 5.0 mm or an 8.0 mm wide backing depending on the channel width formed of Polypropylene or Nylon), which provides flexibility and the ability to contour into various shapes. In one example, the filaments may form a bristle density of approximately 30-50 per cm rough count having a bristle diameter of 0.6 mm. The bristles allow for local minute changes in ground elevation not compensated for the TAAS (10/20) allowing the treatment solution (whether hydrothermal, chemical or both) to be trapped and/or contained under the hood (23a) and create a more stable environment conducive to controlling vegetation in addition to reducing the total amount of treatment solution needed.

An application system connection means (158) preferably secures the application system (20) to the distal end (153) of the self-adjusting arm (16). In some preferred and alternative embodiments, the application system connection means (158) has a generally cylindrical shape with hollow inner core designed to accept and applicator nozzle (22). The application system connection means (158) may be formed of a metal, such as aluminum. An outer wall of the application system connection means (158) includes an angled groove and flap (not shown) designed to secure a top edge of the conical member (23a). The angle of the groove matches the conical angle of the conical member (23a). The application system connection means (158) of such embodiments also has two inner walls (not shown) defining a deferent inner diameter (not shown). The first smaller diameter is preferably sized to mate with the body of the applicator head (21). The larger diameter is preferably used to form a rotary connection. A small groove (not shown) is formed around the circumference in the lower half of the inner wall (not shown). A round disk or circular clip (not shown) is seated in the groove. In some embodiments, ball bearings can be placed in the space between the clip and the inner walls of the application system connection means (158) that allow the hood to rotate, accept, and secure the applicator head (21). In addition, the connection positions the applicator head (21) relative to the hood (23) to provide preferred spray for application to the environment under the hood (23). The hood assembly (23) and applicator head (21) may be attached to the self-adjusting arm (16). For example, an outer part of the body of applicator head (21) may be thread through the hole (155) in a distal end (153) of the self-adjusting arm (16).

The preceding detailed description is merely exemplary in nature and is not intended to limit the described embodiments (examples, options, etc.) or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described above are exemplary implementations provided to enable making or using the embodiments of the disclosure and are not intended to limit the scope of the disclosure. For purposes of the description herein, the terms “upper,” “lower,” “left,” “rear,” “right,” “front,” “vertical,” “horizontal,” and similar terms or derivatives thereof shall relate to the examples as oriented in the drawings and do not necessarily reflect real-world orientations unless specifically indicated. Furthermore, there is no intention to be bound by any expressed or implied theory presented in the preceding detailed description. It is also to be understood that the specific devices, arrangements, configurations, and processes illustrated in the attached drawings, and described in the following specification, are exemplary embodiments (examples), aspects and/or concepts. Hence, specific dimensions and other physical characteristics relating to the embodiments disclosed herein are not to be considered as limiting, except in the context of any claims, which expressly states otherwise. It is understood that “at least one” is equivalent to “a.”

The aspects (examples, alterations, modifications, options, variations, embodiments, and any equivalent thereof) are described with reference to the drawings; it should be understood that the descriptions herein show by way of illustration various embodiments in which claimed inventions may be practiced and are not exhaustive or exclusive. They are presented only to assist in understanding and teach the claimed principles. It should be understood that they are not necessarily representative of all claimed inventions. As such, certain aspects of the disclosure have not been discussed herein. That alternate embodiments may not have been presented for a specific portion of the invention or that further alternate embodiments that are not described may be available for a portion is not to be considered a disclaimer of those alternate embodiments. It will be appreciated that many of those embodiments not described incorporate the same principles of the invention and others that are equivalent. Thus, it is to be understood that other embodiments may be utilized, and functional, logical, organizational, structural and/or topological modifications may be made without departing from the scope and/or spirit of the disclosure.

In order to address various issues and advance the art, the entirety of this application (including the Cover Page, Title, Headings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. In addition, the disclosure includes other inventions not presently claimed. Applicant reserves all rights in those presently unclaimed inventions including the right to claim such inventions.

As such, it should be understood that advantages, embodiments, examples, functional, features, logical, organizational, structural, topological, and/or other aspects of the disclosure are not to be considered limitations on the disclosure as defined by the claims or limitations on equivalents to the claims.

It is also to be noted that, throughout the description and claims of this specification, the word “comprise” and variations of the word, such as “comprising” and “comprises”, is not intended to exclude other variants or additional components, integers or steps. Modifications and improvements to the invention will be readily apparent to those skilled in the art. Such modifications and improvements are intended to be within the scope of this invention.

1. A tracking assembly adapted to be used with a vegetation control system, the assembly comprising:
an articulating frame;
a pivoting frame coupled to the articulating frame along a pivot axis;
a vegetation control application system coupled to the pivoting frame;
a first ground tracking device coupled to the articulating frame configured to contact a surface underneath the articulating frame and position the articulating frame relative to the surface underneath the articulating frame; and
a second ground tracking device coupled to the pivoting frame configured to contact a surface underneath the pivoting frame and position the pivoting frame and vegetation control application system relative to the surface underneath the pivoting frame,
wherein the second ground tracking device pivots the pivoting frame about the pivot axis when an elevation of the surface underneath the second tracking device is different to an elevation of the surface underneath the first tracking device.

2. The assembly of claim 1, wherein the first ground tracking device includes a first wheel attached to the articulating frame and the second ground tracking device includes a second wheel attached to the pivoting frame, wherein each wheel is configured to roll over the surface underneath the corresponding tracking device.

3. The assembly of claim 2, wherein the first ground tracking device includes two first wheels.

4. The assembly of claim 1, wherein the articulating frame further includes an articulating arm, wherein the arm is adapted for detachably mounting the assembly to a vehicle or a mobile platform transporting the assembly and articulates as an elevation of the surface underneath the first tracking device varies.

5. The assembly of claim 4, wherein the articulating frame further includes a second articulating arm, the two articulating arms generally forming part of a variable parallelogram.

6. The assembly of claim 1, wherein the pivoting frame includes a self-adjusting arm coupled to the vegetation control application system for adjusting a position of the self-adjusting arm when the vegetation control application system contacts obstacles.

7. The assembly of claim 1, wherein the vegetation control application system is adapted to deliver hydrothermal treatment solutions, chemical treatment solutions, or a mixture thereof.

8. The assembly of claim 6, wherein the vegetation control application system is adapted to deliver hydrothermal treatment solutions, and includes a saturated steam application nozzle and a hood configured to concentrate saturated steam and moisture from the application nozzle.

9. The assembly of claim 6, wherein the vegetation control application system is adapted to deliver chemical treatment solutions, and includes an application nozzle and a hood configured to contain a chemical solution dispersed.

10. A vegetation control system comprising:
a tank;
optionally, a heating apparatus;
optionally, control circuitry;
a pump configured to receive a solution from the tank and pressurize solution, a tracking assembly; and
and a vegetation control application system connected to the tracking system configured to receive and disperse the pressurized solution,
wherein the tracking assembly is adapted to adjust the vegetation control application system relative to a surface having varying elevations.

11. The system of claim 10, wherein the tracking assembly comprises:
an articulating frame;
a pivoting frame coupled to the articulating frame along a pivot axis and coupled to the vegetation control application system;
a first ground tracking device coupled to the articulating frame configured to contact a surface underneath the articulating frame and position the articulating frame relative to the surface underneath the articulating frame; and
a second ground tracking device coupled to the pivoting frame configured to contact a surface underneath the pivoting frame and position the pivoting frame and vegetation control application system relative to the surface underneath the pivoting frame,
wherein the second ground tracking device pivots the pivoting frame about the pivot axis when an elevation of the surface underneath the second tracking device is different to an elevation of a surface underneath the first tracking device.

12. The system of claim 11, wherein the first ground tracking device includes a first wheel attached to the articulating frame and the second ground tracking device includes a second wheel attached to the pivoting frame, wherein each wheel is configured to roll over the surface underneath the corresponding tracking device.

13. The system of claim 12, wherein the first ground tracking device includes two first wheels.

14. The system of claim 11, wherein the articulating frame further includes an articulating arm, wherein the arm is adapted for detachably mounting the tracking assembly to a vehicle or a mobile platform transporting the assembly and articulates as an elevation of the surface underneath the first tracking device varies.

15. The system of claim 14, wherein the articulating frame further includes a second articulating arm, the two articulating arms generally forming part of a variable parallelogram.

16. The system of claim 11, wherein the pivoting frame includes a self-adjusting arm coupled to the vegetation control application system for adjusting a position of the self-adjusting arm when the vegetation control application system contacts obstacles.

17. The system of claim 10, wherein the vegetation control application system is adapted to deliver hydrothermal treatment solutions, chemical treatment solutions, or mixtures thereof.

18. The system of claim 17, wherein the vegetation control application system is adapted to deliver address thermal treatment solutions, and includes a saturated steam application nozzle and a hood configured to concentrate saturated steam and moisture from the application nozzle.

19. The system of claim 17, wherein the vegetation control application system is adapted to deliver chemical treatment solutions, and includes an application nozzle and a hood configured to contain a chemical solution dispersed.
